(19) United States
(12) Patent Application Publication
(10) Pub. No.: US 2025/0216672 A1
(43) Pub. Date: Jul. 3, 2025

(54) MOLDS FOR MAKING WAVEGUIDE LENS AND WAVEGUIDE LENS

(71) Applicants: Asphetek Solution (Chengdu) Ltd., Chengdu (CN); Asphetek Solution Inc., Hsinchu (TW)

(72) Inventors: HSIAO-CHIEN CHEN, Hsinchu (TW); CHUNG-WU LIU, Hsinchu (TW)

(21) Appl. No.: 18/895,697

(22) Filed: Sep. 25, 2024

(30) Foreign Application Priority Data
Dec. 27, 2023 (CN) 202311818317.1

(51) Int. Cl. G02B 27/01; B29D 11/00; G02F 1/157

(52) U.S. Cl. CPC G02B 27/0101; B29D 11/00692; B29D 11/0073; G02F 1/157

(57) ABSTRACT

The present application provides a mold for making a waveguide lens and a waveguide lens, relating to the technical field of electronic products. The mold for making a waveguide lens comprises: a first mold comprising a first slot defined on one side, the first slot being configured to accommodate an optical waveguide assembly with optical assist function; a second mold configured for molding with the first mold, the second mold comprising a second slot defined on a side of the second mold facing the first mold, wherein the second mold is close to a first surface of the optical waveguide assembly, and the second slot is configured for molding a first lens on the first surface. The present application can reduce the thickness of the waveguide lens while reducing the process of preparing the waveguide lens.

### FIELD

The subject matter relates to the technical field of electronic products, and in particular to molds for making waveguide lens and waveguide lens.

### BACKGROUND

Augmented Reality (AR) is a technology that calculates the position and angle of the camera image in real time and adds the corresponding image, such that the real environment and virtual objects are superimposed onto the same screen or space in real time. Augmented reality devices can utilize optical waveguides to achieve augmented reality.

In the related technology, the process of AR glasses uses the traditional lamination process to laminate various functional materials to complete the AR lenses with various functions. However, due to the use of adhesive for lamination between each functional layer, the AR lenses are thick, and the process is complicated.

### SUMMARY

In view of the above, the present application provides a mold for making a waveguide lens and a waveguide lens that can reduce the thickness of the waveguide lens while reducing the preparation process of the waveguide lens.

The present application provides a mold for making a waveguide lens, comprising: a first mold comprising a first slot defined on one side, the first slot being configured to accommodate an optical waveguide assembly with optical assist function; a second mold configured for molding with the first mold, the second mold comprising a second slot defined on a side of the second mold facing the first mold, wherein the second mold is close to a first surface of the optical waveguide assembly, and the second slot is configured for molding a first lens on the first surface.

It is to be understood that the embodiments of the present application have at least the following advantages: by providing a first mold, since the first mold has a first slot, it is possible to accommodate an optical waveguide assembly with optical auxiliary function, so that the waveguide lens subsequently prepared has an optical function corresponding to the optical waveguide component; by providing a second mold, since the second mold is provided with a second slot on the side facing the first mold, it is possible to form the first lens on a first surface of the optical waveguide assembly with mutual cooperation of the first mold and the second mold, so that there is no need to attach the optical waveguide assembly and the first lens by an adhesive layer, reducing the thickness of the waveguide lens and reducing the process of the preparation of the waveguide lens.

In some possible embodiments, further comprising: a third mold comprising a third slot defined on one side, the third slot being configured to hold the first lens and the optical waveguide assembly; a fourth mold being configured for molding with the third mold, the fourth mold comprises a fourth slot defined on a side of the fourth mold facing the third mold, wherein the fourth mold is close to a second surface of the optical waveguide assembly, the second surface is opposite to the first surface, the fourth mold is configured for molding a second lens on the second surface.

By adopting this technical solution, the thickness of the waveguide lens can be further reduced, and the preparation process of the waveguide lens is further reduced.

In some possible embodiments, wherein the first lens is an objective lens and the second lens is an eyepiece; a slot width of the fourth slot is less than a slot width of the third slot.

In some possible embodiments, the first lens is an eyepiece and the second lens is an objective lens; a slot width of the fourth slot fourth slot is greater than a slot width of the third slot third slot.

The present application also provides a waveguide lens made using the aforementioned mold for making a waveguide lens. The waveguide lens comprising an optical waveguide assembly, and at least one first lens and at least one second lens. The optical waveguide assembly is disposed between the first lens and the second lens, the at least one of the first lens and the at least one second lens is integrally molded and disposed with the optical waveguide assembly.

In some possible implementations, the optical waveguide assembly further comprises a grating structure and an optical function layer provided in a stack; the waveguide lens further comprises an adhesive layer, the grating structure and the optically function layer is affixed to each other by the adhesive layer.

In some possible implementations, the optically function layer comprises one of the following or any combination thereof: an electrochromic dimming function layer, and an eye tracking function layer.

In some possible implementations, the optical waveguide assembly comprises a grating structure; the first lens and the second lens are provided on opposite sides of the grating structure, and each of the first lens and the second lens is integrally molded with the grating structure.

In some possible implementations, the waveguide lens further comprises an electrochromic dimming function layer; the electrochromic dimming function layer is affixed to a third surface of the first lens away from the grating structure.

In some possible implementations, the waveguide lens further comprises an eye tracking function layer, the eye tracking function layer is disposed on a fourth surface of the grating structure that is not affixed by the second lens, the eye tracking function layer is disposed surrounding the second lens.

It will be appreciated that the waveguide lens of the above corresponds to the mold for making the waveguide lens described above, and therefore the beneficial effects that can be achieved thereof can be referred to the beneficial effects in the corresponding method provided above, which will not be repeated herein.

### BRIEF DESCRIPTION OF THE DRAWINGS

FIG. 1 shows a schematic view of a structure of a mold for making a waveguide lens provided in an embodiment.

FIG. 2 shows a schematic view of structure of a mold for making a waveguide lens provided in another embodiment.

FIG. 3 shows a flowchart of the preparation of a waveguide lens provided in an embodiment.

FIG. 4 shows a flowchart of the preparation of a waveguide lens provided in another embodiment.

FIG. 5 shows a schematic view of a structure of a waveguide lens provided in another embodiment.

FIG. 6 shows a schematic view of a structure of a waveguide lens provided in another embodiment.

FIG. 7 shows a schematic view of a structure of a waveguide lens provided in another embodiment.

FIG. 8 shows a schematic view of a structure of a waveguide lens provided in another embodiment.

FIG. 9 shows a schematic view of a structure of a waveguide lens provided in another embodiment.

FIG. 10 shows a schematic view of a structure of a waveguide lens provided in another embodiment.

FIG. 11 shows a schematic view of a structure of a waveguide lens provided in another embodiment.

### DETAILED DESCRIPTION

In order to enable a clearer understanding of the above purposes, features and advantages of the present application, the present application is described in detail below in conjunction with the accompanying drawings and specific embodiments. It is to be noted that the embodiments and the features in the embodiments of the present application may be combined with each other without conflict.

Many specific details are set forth in the following description to facilitate a full understanding of the application, and the embodiments described are only a portion of the embodiments of the application and not all of the embodiments.

Unless otherwise defined, all technical and scientific terms used herein have the same meaning as commonly understood by those skilled in the art belonging to this application. The terms used herein in the specification of this application are used only for the purpose of describing specific embodiments and are not intended to limit this application.

It is further noted that, as used herein, the terms “including”, “comprising”, or any other variant thereof, are intended to encompass non-exclusive inclusion, such that a process, method, article, or apparatus comprising a set of elements includes not only those elements, but also other elements that are not expressly listed or are inherent to such process, method, article, or apparatus. also includes other elements that are not expressly listed or that are inherent to such process, method, article or device. Without further limitation, the fact that an element is defined by the phrase “includes a . . . ” does not preclude the existence of another identical element in the process, method, article or apparatus that includes that element.

In this application, “at least one” means one or more, and “more than one” means two or more. “and/or” describes an association relationship of the associated objects, indicating that three relationships may exist, for example, A and/or B may indicate: the existence of A alone, the existence of both A and B, and the existence of B alone, wherein A and B may be singular or plural. The terms “first”, “second”, “third”, “fourth”, etc., if present, are used in the specification and claims of the present application and the accompanying drawings. “and the like, if present, are used to distinguish similar objects and are not used to describe a particular order or sequence.

In the embodiments of the present application, the words “exemplary” or “for example” are used to denote examples, illustrations, or descriptions. Any embodiment or design solution described as “exemplary” or “for example” in the embodiments of the present application should not be construed as being preferred or more advantageous than other embodiments or design solutions. Rather, the use of the words “exemplary” or “for example” is intended to present the relevant concepts in a specific manner.

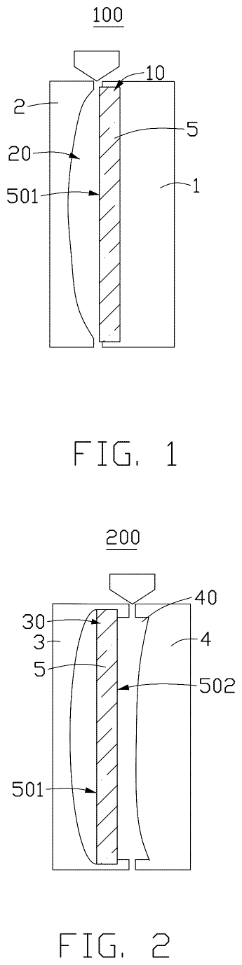

Referring to FIG. 1, a schematic view of a structure of a mold for making a waveguide lens provided by an embodiment is shown. The mold 100 for making the waveguide lens includes a first mold 1 and a second mold 2. The first mold 1 includes a first slot 10 on one side, and the first slot 10 is used for placing an optical waveguide assembly 5 with optical assist function. The second mold 2 is used for molding together with the first mold 1, and the second mold 2 has a second slot 20 on the side toward the first mold 1. Wherein, the optical waveguide assembly 5 includes a first surface 501 near the second mold 2, and the second slot 20 is used for molding a first lens (FIG. 1). 2, the second slot 20 is configured to mold a first lens (not shown in FIG. 1) on the first surface 501.

In some embodiments, the shape of the first slot 10 is not specifically limited. The shape of the first slot 10 matches the shape of the optical waveguide assembly 5 to ensure that the optical waveguide assembly 5 can be securely seated within the first slot 10.

In some embodiments, the first lens is molded on the first surface 501 of the optical waveguide assembly 5 by a casting process. In this way, the first lens is molded integrally with the optical waveguide assembly 5, thereby eliminating the need to secure the first lens to the optical waveguide assembly 5 by adhesive, and thereby reducing the thickness of the waveguide lens.

Referring to FIG. 2, there is shown a schematic view of another structure of a mold for making the waveguide lens. The mold 200 for making the waveguide lens further includes a third mold 3 and a fourth mold 4. A third slot 30 is provided on one side of the third mold 3, and the third slot 30 is used for placing the first lens and the optical waveguide assembly 5. The fourth mold 4 is configured to merge with the third mold 3, and a fourth slot 40 is provided on the side of the fourth mold 4 facing the third mold 3. Wherein, the optical waveguide assembly 5 further includes a second surface 502. The second surface 502 is disposed opposite the first surface 501, and the second surface 502 is disposed near the fourth mold 4. The fourth slot 40 is configured to mold a second lens (not shown in FIG. 2) on the second surface 502.

It should be noted that the third slot 30 shown in FIG. 2 is configured to hold the first lens and the optical waveguide assembly 5. In practice, the third slot 30 may also be designed to hold only the optical waveguide assembly 5. That is, the optical waveguide assembly 5 is cast on one side and the second lens is molded integrally on the second surface 502.

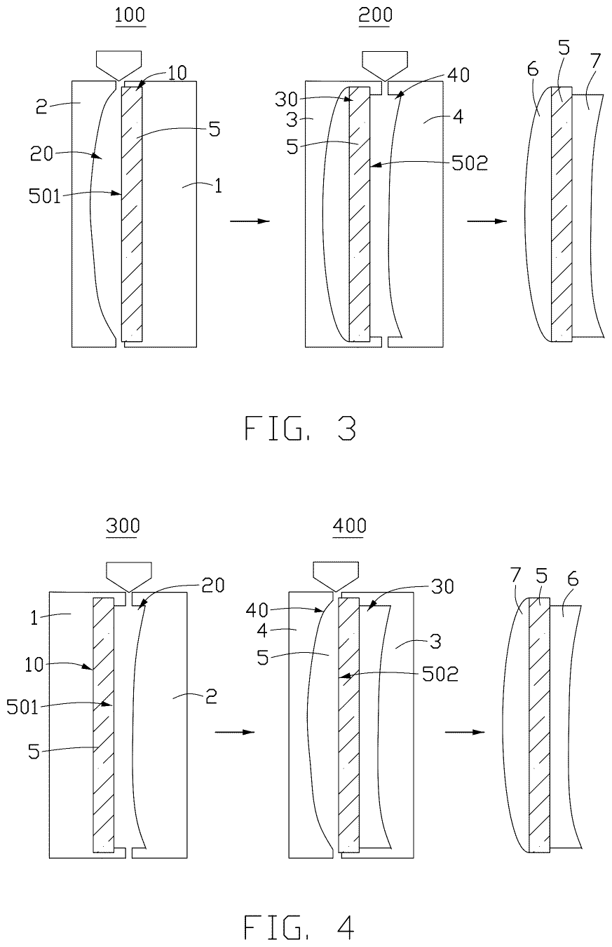

Referring to FIG. 3, a flowchart of the preparation of a waveguide lens provided by an embodiment of the present application, the third slot 30 is configured to accommodate the first lens 6 and the optical waveguide assembly 5. That is to say, the mold 200 for making the waveguide lens and the mold 100 for making the waveguide lens are used in conjunction with each other.

Specifically, the mold 100 for making the waveguide lens is first configured to mold the first lens 6 on the first surface 501 of the optical waveguide assembly 5 by a casting process. Then, using the mold 200 for making the waveguide lens, the integrally molded first lens 6 and the optical waveguide assembly 5 are accommodated inside the third slot 30, and the second lens 7 is molded on the second surface 502 of the optical waveguide assembly 5 by a casting process.

It is to be understood that, by the above-described double-sided casting on the optical waveguide assembly 5, it is possible to make it possible that neither the first lens 6 nor the second lens 7 needs to be affixed to the optical waveguide assembly 5 by means of an adhesive. Thereby, the thickness of the waveguide lens is further reduced, and the preparation process of the waveguide lens is further reduced.

In some embodiments, the third slot 30 is used for the optical waveguide assembly 5. That is, the mold 200 for making the waveguide lens is used separately to mold the second lens 7 on the second surface 502 of the optical waveguide assembly 5 by pouring.

Referring again to FIG. 3, the first lens 6 molded by the mold 100 for making the waveguide lens is an objective lens, the second lens 7 molded by the mold 200 for making the waveguide lens is an eyepiece, and the slot width of the fourth slot 40 is less than the slot width of the third slot 30.

Referring to FIG. 4, shows a flow chart of the preparation of another type of waveguide lens provided in this embodiment. The first lens 6 molded by the mold 300 for making the waveguide lens is an eyepiece, and the second lens 7 molded by the mold 400 for making the waveguide lens is an objective lens; the slot width of the fourth slot 40 is larger than the slot width of the third slot 30.

It should be noted that the specific structure of the optical waveguide assembly 5 is described in detail in the subsequent embodiments, and in order to avoid repetition, it will not be repeated here.

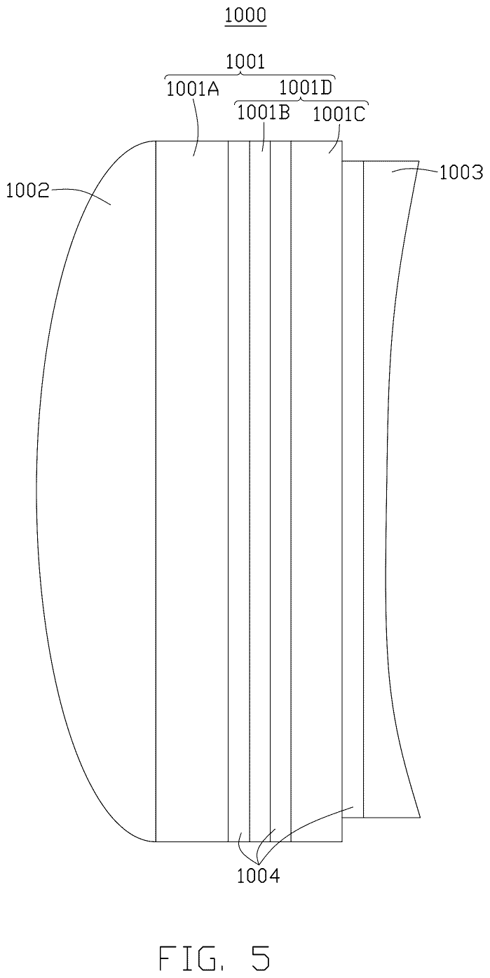

Referring to FIG. 5, a schematic view of a structure of a waveguide lens 1000 provided by an embodiment of the present application is shown. The waveguide lens 1000 provided in this embodiment is made using a mold for making a waveguide lens as described above, and the waveguide lens 1000 includes a light waveguide assembly 1001, and a first lens 1002 and a second lens 1003. The light waveguide assembly 1001 is disposed between the first lens 1002 and the second lens 1003, and at least one of the first lens 1002 and the second lens 1003 is integrally molded with the optical waveguide assembly 1001.

In some embodiments, the optical waveguide assembly 1001 includes a grating structure 1001A and an optical function layer 1001D provided in a stack. The waveguide lens 1000 further includes an adhesive layer 1004, and the grating structure 1001A and the optical function layer 1001D are affixed by the adhesive layer 1004 provided therebetween.

Referring again to FIG. 5, the first lens 1002 and the grating structure 1001A are set up integrally molded. The optical function layer 1001D includes an electrochromic dimming function layer 1001B and an eye tracking function layer 1001C.

Specifically, the first lens 1002 is an objective lens. The grating structure 1001A, the electrochromic dimming function layer 1001B, and the eye tracking function layer 1001C are provided in sequential layers. An adhesive layer 1004 is provided between the grating structure 1001A and the electrochromic dimming function layer 1001B. An adhesive layer 1004 is provided between the electrochromic dimming function layer 1001B and the eye tracking function layer 1001C. The grating structure 1001A, the electrochromic dimming function layer 1001B, and the eye tracking function layer 1001C are affixed by the adhesive layer 1004.

In addition, the second lens 1003 shown in FIG. 5 is an eyepiece, and the second lens 1003 is affixed to the eye tracking function layer 1001C by the adhesive layer 1004.

It is to be understood that the optical function layer 1001D may also be other layer structures having optical auxiliary functions. The present embodiment does not specifically limit the number and types of function layers included in the optical function layer.

In some embodiments, the material of the adhesive layer 1004 may be an OCA adhesive or an OCR adhesive, and the adhesive layer 1004 of such material is colorless and transparent and has a high transmittance rate so as not to affect the optical performance of the waveguide lens 1000.

In some embodiments, the material of the grating structure 1001A may be a geometric waveguide, a diffractive waveguide, a surface relief grating waveguide, and a holographic grating waveguide. This embodiment does not specifically limit the material of the grating structure 1001A.

In some embodiments, the first lens 1002 and the second lens 1003 may be shaped as spherical mirrors, aspherical mirrors, or double aspherical mirrors, and the like. The present embodiments do not specifically limit this.

In some embodiments, the material of the first lens 1002 and the second lens 1003 may be an optical lens material such as glass, cyclic olefin copolymer, polymethylmethacrylate, and polycarbonate. This embodiment does not specifically limit the materials of the first lens 1002 and the second lens 1003.

In some embodiments, the first lens 1002 and the second lens 1003 have a refractive index ranging from 1.4 to 2.0 and a radius of curvature of the lens ranging from 25 to 300.

In some embodiments, the shape of the waveguide lens 1000 may be circular, oval, rectangular, and square, among others. This embodiment does not specifically limit the shape of the waveguide lens 1000.

In some embodiments, the waveguide lens 1000 has a maximum width ranging from 3centimeters to 30 centimeters. The waveguide lens 1000 may be a single-piece lens or a two-piece lens.

In some embodiments, the maximum thickness of the waveguide lens 1000 ranges from 0.2 mm to 20 mm.

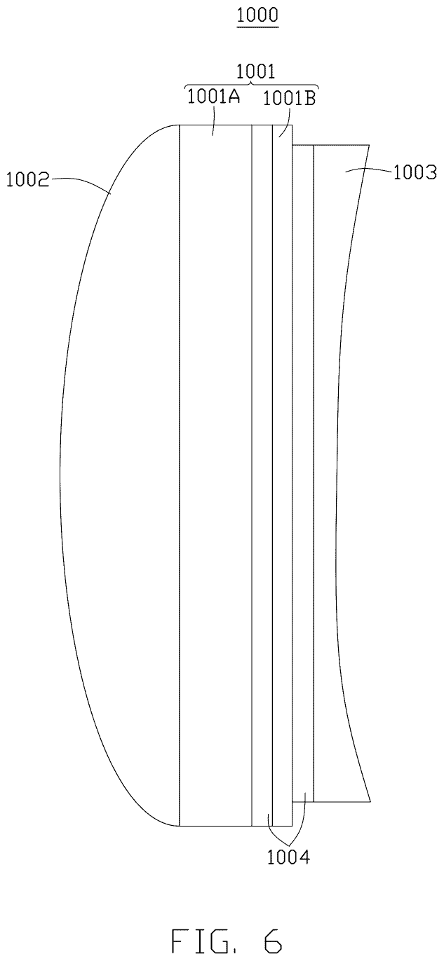

Referring to FIG. 6, another structure of the waveguide lens 1000 provided by an embodiment of the present application is schematically shown. The first lens 1002 shown in FIG. 6 is an objective lens and the second lens 1003 is an eyepiece. The optical waveguide assembly 1001 includes a grating structure 1001A and an electrochromic dimming function layer 1001B.

Specifically, the first lens 1002 and the grating structure 1001A are integrally molded and provided. An adhesive layer 1004 is provided between the grating structure 1001A and the electrochromic dimming function layer 1001B, and the grating structure 1001A and the electrochromic dimming function layer 1001B are affixed by the adhesive layer 1004. An adhesive layer 1004 is provided between the second lens 1003 and the electrochromic dimming function layer 1001B, and the second lens 1003 and the electrochromic dimming function layer 1001B are affixed by the adhesive layer 1004.

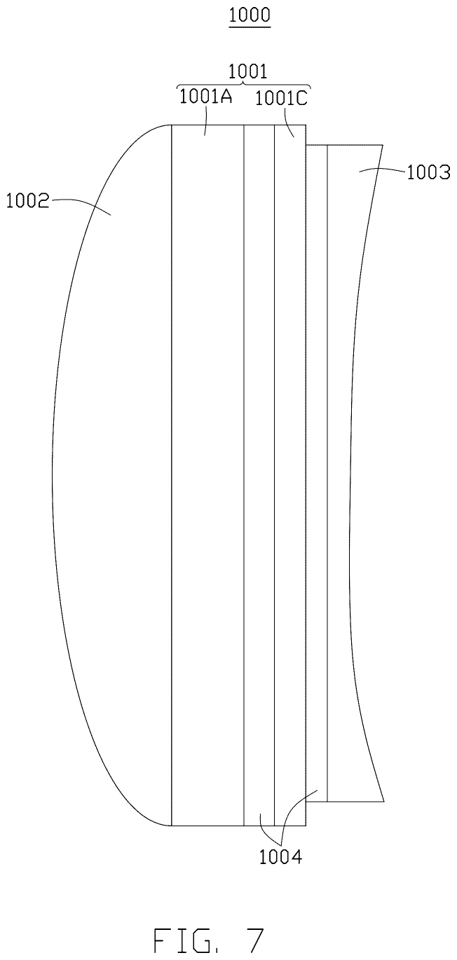

Referring to FIG. 7, a schematic diagram of yet another structure of a waveguide lens 1000 provided by an embodiment of the present application is shown. The first lens 1002 shown in FIG. 7 is an objective lens and the second lens 1003 is an eyepiece; the optical waveguide assembly 1001 includes a grating structure 1001A and an eye tracking function layer 1001C.

Specifically, the first lens 1002 and the grating structure 1001A are provided integrally molded. An adhesive layer 1004 is provided between the grating structure 1001A and the eye tracking function layer 1001C, and the grating structure 1001A and the eye tracking function layer 1001C are affixed by the adhesive layer 1004. An adhesive layer 1004 is provided between the second lens 1003 and the eye tracking function layer 1001C, and the second lens 1003 and the eye tracking function layer 1001C are affixed by the adhesive layer 1004.

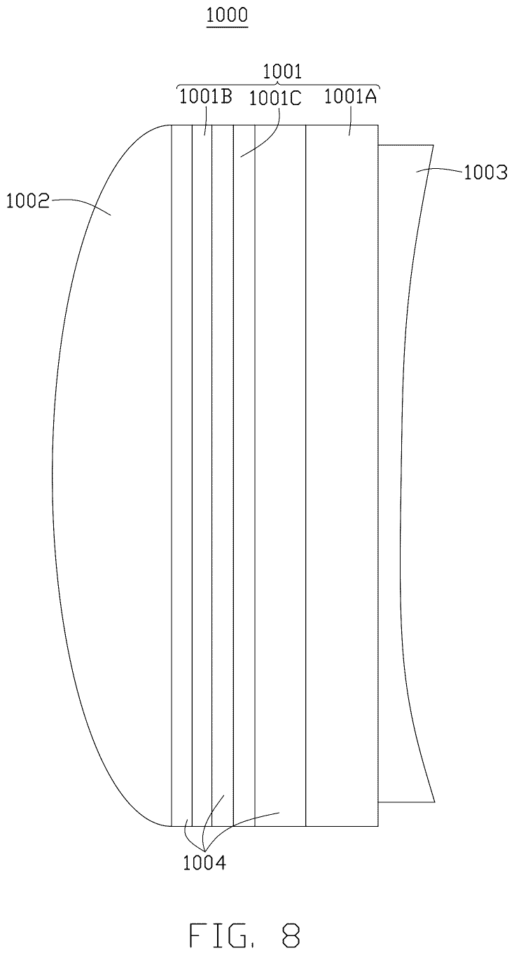

Referring to FIG. 8, a schematic diagram of a further structure of the waveguide lens 1000 provided by an embodiment of the present application is shown. The first lens 1002 shown in FIG. 8 is an objective lens, and the second lens 1003 is an eyepiece; the optical waveguide assembly 1001 includes a grating structure 1001A, an electrochromic dimming function layer 1001B, and an eye tracking function layer 1001C.

Specifically, the second lens 1003 and the grating structure 1001A are provided integrally molded. The grating structure 1001A, the electrochromic dimming function layer 1001B, and the eye tracking function layer 1001C are provided in sequential layers. An adhesive layer 1004 is provided between the grating structure 1001A and the eye-tracking function layer 1001C, and the grating structure 1001A and the eye-tracking function layer 1001C are affixed to each other by the adhesive layer 1004. An adhesive layer 1004 is provided between the electrochromic dimming function layer 1001B and the eye tracking function layer 1001C, and the electrochromic dimming function layer 1001B and the eye tracking function layer 1001C are affixed by the adhesive layer 1004. An adhesive layer 1004 is provided between the electrochromic dimming function layer 1001B and the first lens 1002, and the electrochromic dimming function layer 1001B and the first lens 1002 are affixed by the adhesive layer 1004.

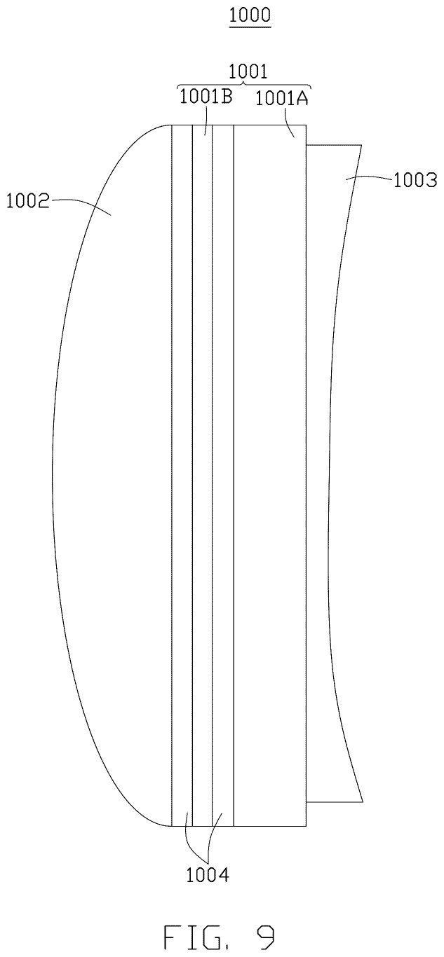

Referring to FIG. 9, a schematic diagram of a further structure of the waveguide lens 1000 provided by an embodiment of the present application is shown. The first lens 1002 shown in FIG. 9 is an objective lens and the second lens 1003 is an eyepiece; the optical waveguide assembly 1001 includes a grating structure 1001A and an electrochromic dimming function layer 1001B.

Specifically, the second lens 1003 and the grating structure 1001A are integrally molded and provided. An adhesive layer 1004 is provided between the grating structure 1001A and the electrochromic dimming function layer 1001B, and the grating structure 1001A and the electrochromic dimming function layer 1001B are affixed by the adhesive layer 1004. An adhesive layer 1004 is provided between the electrochromic dimming function layer 1001B and the first lens 1002, and the electrochromic dimming function layer 1001B and the first lens 1002 are affixed by the adhesive layer 1004.

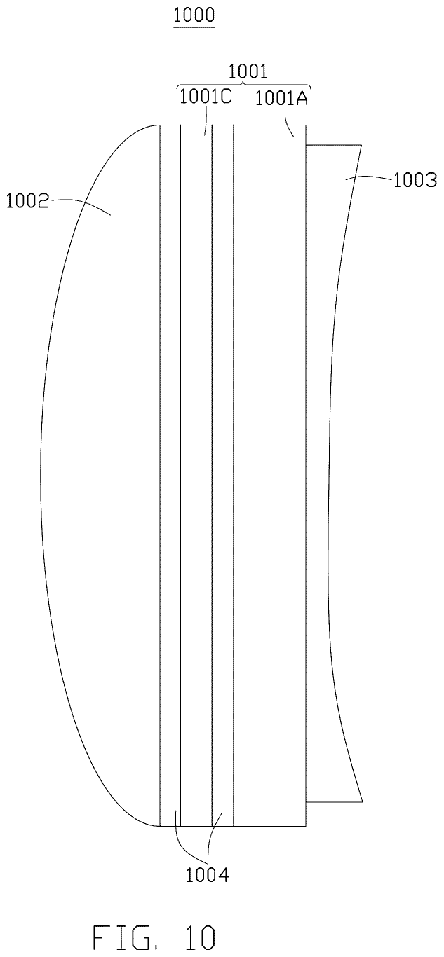

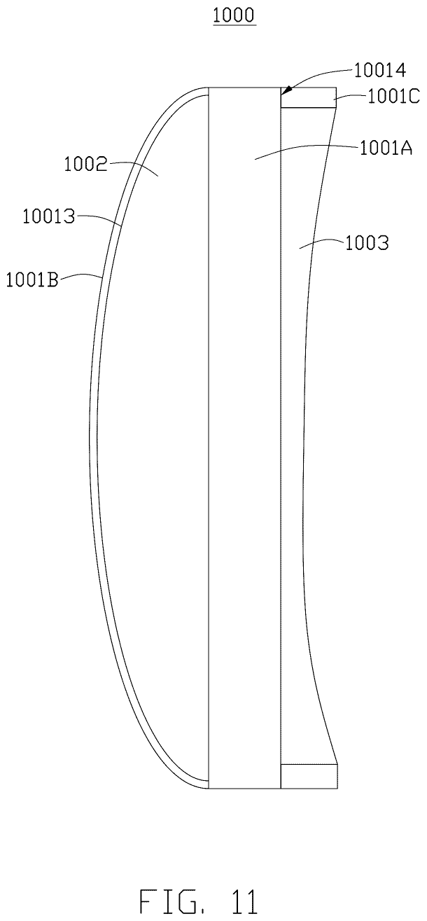

Referring to FIG. 10, a schematic diagram of a further structure of a waveguide lens 1000 provided by an embodiment of the present application is shown. The first lens 1002 shown in FIG. 9 is an objective lens and the second lens 1003 is an eyepiece. The optical waveguide assembly 1001 includes a grating structure 1001A and an eye tracking function layer 1001C.

Specifically, the second lens 1003 and the grating structure 1001A are provided integrally molded. An adhesive layer 1004 is provided between the grating structure 1001A and the eye tracking function layer 1001C, and the grating structure 1001A and the eye tracking function layer 1001C are affixed by the adhesive layer 1004. An adhesive layer 1004 is provided between the eye tracking function layer 1001C and the first lens 1002, and the eye tracking function layer 1001C and the first lens 1002 are affixed by the adhesive layer 1004.

Referring to FIG. 11, the first lens 1002 and the second lens 1003 are provided on opposite sides of the grating structure 1001A, and both are integrally molded and provided with the grating structure 1001A. The first lens 1002 is an objective lens and the second lens 1003 is an eyepiece.

The waveguide lens 1000 shown in FIG. 11 further includes an electrochromic dimming function layer 1001B, the electrochromic dimming function layer 1001B is affixed to a third surface 10013 of the first lens 1002 away from the grating structure 1001A.

In some embodiments, the electrochromic dimming function layer 1001B is formed by coating an electrochromic (EC) material on a third surface 10013 of the first lens 1002 away from the grating structure 1001A.

Referring again to FIG. 11, the waveguide lens 1000 further includes an eye-tracking function layer 1001C, the eye-tracking function layer 1001C is provided on the fourth surface 10014 of the grating structure 1001A that is not affixed by the second lens 1003. The eye-tracking function layer 1001C is provided surrounding the second lens 1003. Through the setting of such structure, it is possible to increase the optical assisting function of the waveguide lens 1000 as much as possible while reducing the thickness of the waveguide lens 1000, so as to improve the user's experience.

The above mentioned are only the specific implementations of the present application, but the scope of protection of the present application is not limited to this, and any changes or substitutions within the technical scope disclosed in the present application shall be covered by the scope of protection of the present application.

What is claimed is:

1. A mold configured for making a waveguide lens, the mold comprising:
a first mold comprising a first slot defined on one side, the first slot being configured to accommodate an optical waveguide assembly with optical assist function; and
a second mold configured for molding with the first mold, the second mold comprising a second slot defined on a side of the second mold facing the first mold,
wherein the second mold is close to a first surface of the optical waveguide assembly, and the second slot is configured for molding a first lens on the first surface.

2. The mold of claim 1, further comprising:
a third mold comprising a third slot defined on one side, the third slot being configured to hold the first lens and the optical waveguide assembly; and
a fourth mold being configured for molding with the third mold, the fourth mold comprises a fourth slot defined on a side of the fourth mold facing the third mold,
wherein the fourth mold is close to a second surface of the optical waveguide assembly, the second surface is opposite to the first surface, the fourth mold is configured for molding a second lens on the second surface.

3. The mold of claim 2, wherein the first lens is an objective lens and the second lens is an eyepiece;
a slot width of the fourth slot is less than a slot width of the third slot.

4. The mold of claim 2, wherein the first lens is an eyepiece and the second lens is an objective lens;
a slot width of the fourth slot is greater than a slot width of the third slot.

5. The mold of claim 1, wherein the first lens is molded on the first surface of the optical waveguide assembly by a casting process.

6. A waveguide lens made from a mold;
the waveguide lens comprising an optical waveguide assembly, at least one first lens and at least one second lens, wherein
the optical waveguide assembly is disposed between the first lens and the second lens, the at least one of the first lens and the at least one second lens is integrally molded and disposed with the optical waveguide assembly; and
the mold configured for making waveguide lens, the mold comprising:
a first mold comprising a first slot defined on one side, the first slot being configured to accommodate the optical waveguide assembly with optical assist function; and
a second mold configured for molding with the first mold, the second mold comprising a second slot defined on a side of the second mold facing the first mold,
wherein the optical waveguide assembly comprises a first surface close the second mold, the second slot is configured for molding the first lens on the first surface.

7. The waveguide lens of claim 6, wherein the optical waveguide assembly further comprises a grating structure and an optical function layer provided in a stack;
the waveguide lens further comprises an adhesive layer, the grating structure and the optically function layer is affixed to each other by the adhesive layer.

8. The waveguide lens of claim 7, wherein the optically function layer comprises:
an electrochromic dimming function layer, and an eye tracking function layer.

9. The waveguide lens of claim 6, wherein the optical waveguide assembly comprises a grating structure;
the first lens and the second lens are provided on opposite sides of the grating structure, and each of the first lens and the second lens is integrally molded with the grating structure.

10. The waveguide lens of claim 9, further comprising an electrochromic dimming function layer; wherein the electrochromic dimming function layer is affixed to a third surface of the first lens away from the grating structure.

11. The waveguide lens of claim 9, further comprising an eye tracking function layer, wherein the eye tracking function layer is disposed on a fourth surface of the grating structure that is not affixed by the second lens, the eye tracking function layer is disposed surrounding the second lens.

12. The waveguide lens of claim 7, wherein a material of the grating structure comprises one of a geometric waveguide, a diffractive waveguide, a surface relief grating waveguide and a holographic grating waveguide.

13. The waveguide lens of claim 6, wherein each of the first lens and the second lens is a spherical mirror, an aspherical mirror or a double aspherical mirror; a material of each of the first lens and the second lens is an optical lens material comprises glass, cyclic olefin copolymer, polymethylmethacrylate and polycarbonate.

14. The waveguide lens of claim 6, wherein each of the first lens and the second lens has a refractive index ranging from 1.4 to 2.0, and each of the first lens and the second lens has a radius of curvature ranging from 25 to 300.

15. The waveguide lens of claim 6, wherein a shape of the waveguide lens is a circular, an oval, a rectangular and a square; the waveguide lens has a maximum width ranging from 3 centimeters to 30 centimeters; a maximum thickness of the waveguide lens ranges from 0.2 mm to 20 mm.

16. The waveguide lens of claim 7, wherein a material of the adhesive layer comprises an OCA adhesive or an OCR adhesive.

17. The waveguide lens of claim 6, the mold further comprising:
a third mold comprising a third slot defined on one side, the third slot being configured to hold the first lens and the optical waveguide assembly; and
a fourth mold configured for molding with the third mold, the fourth mold comprising a fourth slot defined on a side of the fourth mold facing the third mold;
the optical waveguide assembly further comprising a second surface, the second surface is disposed opposite to the first surface and provided close to the fourth mold, the fourth mold is configured for molding a second lens on the second surface.

18. The waveguide lens of claim 17, wherein the first lens is an objective lens and the second lens is an eyepiece;
a slot width of the fourth slot is less than a slot width of the third slot.

19. The waveguide lens of claim 17, wherein the first lens is an eyepiece and the second lens is an objective lens;
a slot width of the fourth slot is greater than a slot width of the third slot.

20. The waveguide lens of claim 17, wherein the first lens is molded on the first surface of the optical waveguide assembly by a casting process.
